(19) United States
(12) Patent Application Publication
(10) Pub. No.: US 2012/0093374 A1
(43) Pub. Date: Apr. 19, 2012

(54) ELECTRONIC DEVICE AND METHOD FOR IDENTIFYING USE BY UNAUTHORIZED USERS

(75) Inventors: CHAO-TSUNG FAN, Tu-Cheng (TW); CHUNG-JEN HSIEH, Tu-Cheng (TW)

(73) Assignee: HON HAI PRECISION INDUSTRY CO., LTD., Tu-Cheng (TW)

(21) Appl. No.: 13/094,761

(22) Filed: Apr. 26, 2011

(30) Foreign Application Priority Data
Oct. 14, 2010 (TW) 99135037

(51) Int. Cl. G06K 9/00

(52) U.S. Cl. 382/116; 382/118

(57) ABSTRACT

In a method for identifying use by unauthorized users of an electronic device, a digital image of a user is captured when the user powers on the electronic device. The digital image of the user is compared with predefined images of authorized users of the electronic device to determine whether the user is an authorized user, if there are predefined images stored in the storage system. A message is sent to notify an owner of the electronic device that an unauthorized user is using the electronic device if the user is an unauthorized user.

### BACKGROUND

1. Technical Field

Embodiments of the present disclosure relate generally to security of electronic devices, and more particularly, to an electronic device and method for identifying use by unauthorized users.

2. Description of Related Art

Electronic devices, such as, notebooks, smart phones, and feature-rich mobile phones usually are fairly expensive. Most owners will go to great lengths to use software to secure their electronic devices. These precautions, while extremely necessary and effective against data theft, have no affect whatsoever in the case of physical theft or loss. In most electronic devices, there are some basic levels of security available against physical theft or loss, like SIM card locks or device locks. However, these particular obstacles are easily surmountable, and do not offer any help for recovery from theft or loss of the electronic devices.

### BRIEF DESCRIPTION OF THE DRAWINGS

FIG. 1 is a block diagram of one embodiment of an electronic device.

FIG. 2 is a schematic diagram illustrating one example of a placement of an image capturing device of the electronic device of FIG. 1.

FIG. 3 is a flowchart of one embodiment of a method for identifying use by unauthorized users of the electronic device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

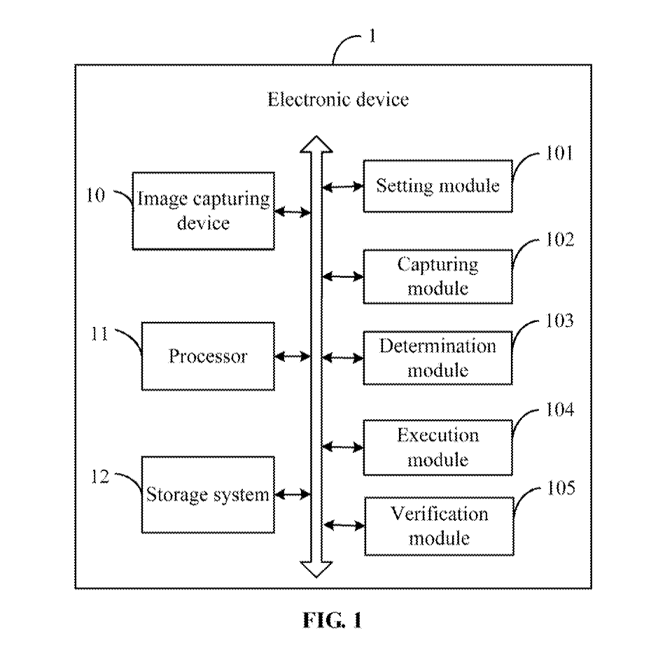

FIG. 1 is a block diagram of one embodiment of an electronic device 1. In the embodiment, the electronic device 1 includes an image capturing device 10, a processor 11, a storage system 12, a setting module 101, a capturing module 102, a determination module 103, an execution module 104, and a verification module 105. In one embodiment, the electronic device 1 may be a notebook, a mobile phone, a personal digital assistant (PDA), or a mobile internet device (MID), for example. It should be apparent that FIG. 1 is only one example of the electronic device 1 that can be included with more or fewer components than shown in other embodiments, or a different configuration of the various components.

The modules 101-105 may include one or more computerized instructions in the form of one or more programs that are stored in the storage system 12 or a computer-readable medium of the electronic device 1, executed by the processor 11 to perform operations of the electronic device 1. In general, the word “module”, as used herein, refers to logic embodied in hardware or firmware, or to a collection of software instructions, written in a programming language, such as, Java, C, or Assembly. One or more software instructions in the modules may be embedded in firmware, such as EPROM. The modules described herein may be implemented as either software and/or hardware modules and may be stored in any type of computer-readable medium or other storage device.

The storage system 12 stores one or more programs, such as programs of an operating system, and other applications of the electronic device 1. In one embodiment, the storage system 12 may be random access memory (RAM) for temporary storage of information, and/or a read only memory (ROM) for permanent storage of information. In other embodiments, the storage system 12 may also be an external storage device, such as a hard disk, a storage card, or a data storage medium. The processor 11 executes computerized operations of the electronic device 1 and other applications, to provide functions of the electronic device 1.

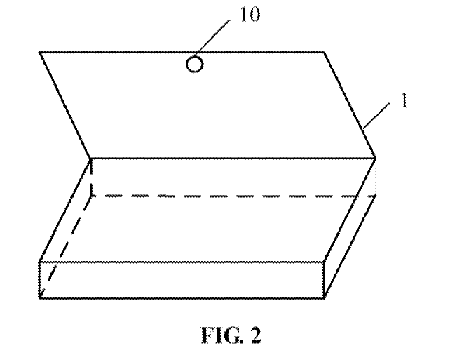

The image capturing device 10 may be a charge coupled device (CCD), or a digital camera, and is operable to capture digital images of a user when the electronic device 1 is powered on by the user. In one example, as shown in FIG. 2, the image capturing device 10 may be mounted on a display screen of the electronic device 1 to easily capture the digital images of the user.

The capturing module 102 is operable to capture a digital image of the user using the image capturing device 10 when the user powers on the electronic device 1, and determine whether there are predefined images of authorized users of the electronic device 1 stored in the storage system 12.

In one embodiment, the predefined images of the authorized users may be collected by the setting module 101 using the image capturing device 10, and stored in the storage system 12. In the embodiment, the authorized users include an owner of the electronic device, and other people that are allowed by the owner to use the electronic device 1. Each of the predefined images of the authorized users may include a facial image of an authorized user. Furthermore, if no predefined image of the authorized users is stored in the storage system 12, a password may be preset and stored in the storage system 10 by the setting module 101. Thus, the electronic device 1 may not be operated by unauthorized users of the electronic device 1 unless a valid password is input. The password may be, for example, a fingerprint, a vocal print, or a character string set by the owner. Details of the password and the predefined images of the authorized users are provided below.

The determination module 103 is operable to compare the digital image of the user with the predefined images to determine whether the user is an authorized user of the electronic device 1, if there are predefined images stored in the storage system 10. In one embodiment, the determination module 103 may extract facial characteristics, such as nose, eyes and mouth data, from both the digital image and each of the predefined images using a facial recognition algorithm. Then the determination module 103 compares the facial characteristics of the digital image with the facial characteristics of the predefined images. If the facial characteristics of the digital image are the same as or similar to the facial characteristics of any one of the predefined images, the user may be determined as an authorized user, otherwise, the user may be determined as an unauthorized user.

The execution module 104 is operable to send a message to a preset E-mail address or a mobile phone of the owner to notify the owner that an unauthorized user is using the electronic device 1, if the user is an unauthorized user of the electronic device 1. The preset E-mail address and a phone number of the mobile phone may be preset by the owner using the setting module 101. If the user is an authorized user, the electronic device 1 can be operated normally. In one embodiment, the message may include information of the unauthorized user, such as, the digital image of the unauthorized user, time information that the digital image is captured, and an IP address used by the electronic device 1. As thus, the owner of the electronic device 1 may retrieve the electronic device 1 with the help of the information of the unauthorized user, under the condition that the electronic device 1 is stolen or lost. Additionally, when the message is sent, the electronic device 1 may be powered off, restarted, or locked according to requirements of the owner.

The verification module 105 is operable to receive a password input by the user within a predetermined period of time, such as three seconds, or five seconds, if there is no predefined image of the authorized users stored in the storage system 12, and determine whether the input password is valid.

Upon the condition that the input password is invalid, the execution module 104 is further operable to send the message to the preset E-mail address or the mobile phone. When the user inputs a valid password in the predetermined period of time, the electronic device 1 can be operated normally by the user.

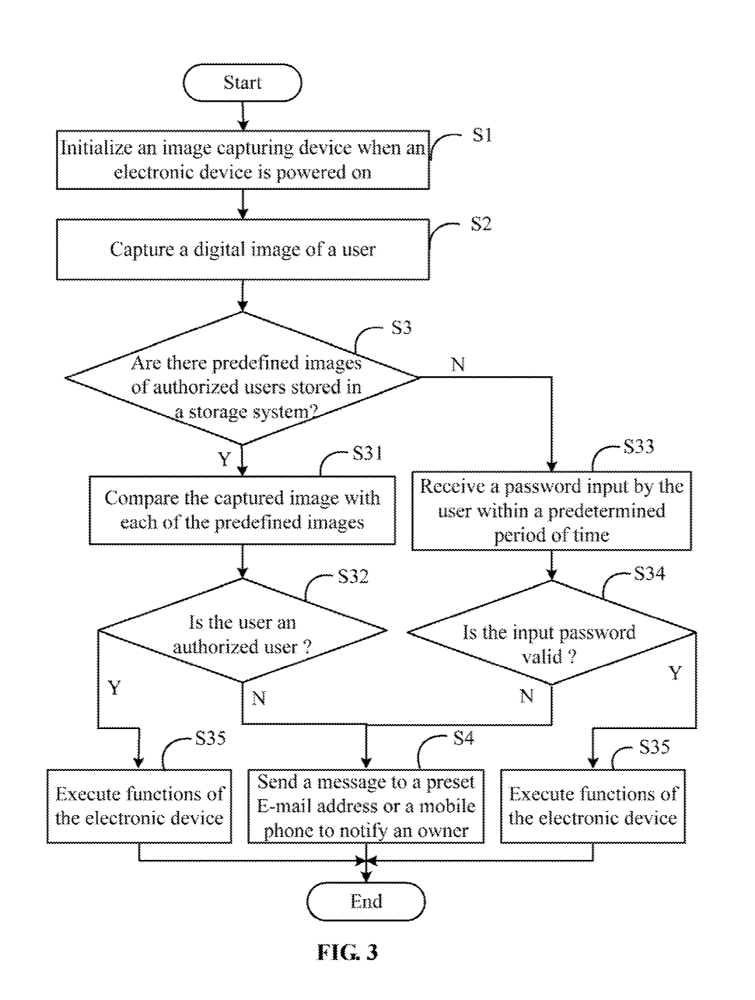

FIG. 3 is a flowchart of one embodiment of a method for identifying use by unauthorized users of the electronic device 1 of FIG. 1. Depending on the embodiment, additional blocks may be added, others removed, and the ordering of the blocks may be changed.

In block S1, the capturing module 101 initializes the image capturing device 10 when the electronic device 1 is powered on by a user.

In block S2, the capturing module 102 captures a digital image of the user using the image capturing device 10. In block S3, the capturing module 102 determines whether there are predefined images of authorized users of the electronic device 1 stored in the storage system 12. If there are predefined images of the authorized users stored in the storage system 12, block S31 is implemented. Otherwise, if no predefined image of the authorized users is stored in the storage system 12, block S33 is implemented. The predefined images of the authorized users may be pre-collected and stored in the storage system 12 in advance using the setting module 101 as described above.

In block S31, the determination module 103 compares the digital image with each of the predefined images of the authorized users. In block S32, the determination module 103 determines whether the user is an authorized user of the electronic device 1 according to the comparison. If the user is an authorized user of the electronic device 1, block S35 is implemented. Otherwise, if the user is an unauthorized user of the electronic device 1, block S4 is implemented. Details of the comparison between the digital image and the predefined images are described in the paragraph [0013].

In block S33, the verification module 105 receives a password input by the user within a predetermined period of time, such as three seconds, or five seconds. In block S34, the verification module 105 determines whether the input password is valid. If the input password is valid, block S35 is implemented. Otherwise, if the input password is invalid, block S4 is implemented. The password may be preset by the owner of the electronic device 1 using the setting module 101 as described above. For example, the password may be, a fingerprint, a vocal print, or a character string preset by the owner.

In block S35, the electronic device 1 executes functions according to operations of the user, ends the procedure.

In block S4, the execution module 104 sends a message to a preset E-mail address or a mobile phone of the owner to notify the owner that an unauthorized user is using the electronic device 1. The preset E-mail address and a phone number of the mobile phone may be preset by the owner using the setting module 101. In one embodiment, the message may include information of the unauthorized user, such as, the captured digital image of the unauthorized user, time information that the digital image is captured, and an IP address used by the electronic device 1. As thus, the owner may retrieve the electronic device 1 with the help of the information when the electronic device 1 is stolen or lost.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A method for identifying use by unauthorized users of an electronic device that comprises an image capturing device, the method comprising:
capturing a digital image of a user using the image capturing device when the user powers on the electronic device, and determining whether there are predefined images of authorized users of the electronic device stored in a storage system of the electronic device;
comparing the digital image with each of the predefined images to determine whether the user is an authorized user of the electronic device, if there are predefined images stored in the storage system; and
sending a message to a preset E-mail address or a mobile phone of an owner of the electronic device to notify the owner that an unauthorized user is using the electronic device in response to the user being an unauthorized user of the electronic device.

2. The method according to claim 1, further comprising:
receiving a password input by the user within a predetermined period of time, if there is no predefined image of the authorized users stored in the storage system;
determining whether the input password is valid; and
sending the message to the preset E-mail address or the mobile phone upon the condition that the input password is invalid.

3. The method according to claim 2, further comprising:
collecting the predefined images of the authorized users using the image capturing device;
presetting the password, the E-mail address and a phone number of the mobile phone; and
storing the predefined images, the password, the E-mail address and the phone number in the storage system.

4. The method according to claim 1, wherein the message comprises the digital image of the user, time information that the digital image is captured, and an IP address used by the electronic device.

5. The method according to claim 1, wherein the password is a fingerprint, a vocal print, or a character string preset by the owner.

6. The method according to the claim 1, wherein the authorized users comprises the owner and other persons that are allowed by the owner to use the electronic device.

7. An electronic device, comprising:
an image capturing device;
at least one processor;
a storage system; and
one or more programs stored in the storage system and being executable by the at least one processor, the one or more programs comprising:
a capturing module operable to capture a digital image of a user using the image capturing device when the user powers on the electronic device, and determine whether there are predefined images of authorized users of the electronic device stored in the storage system;
a determination module operable to compare the digital image with each of the predefined images to determine whether the user is an authorized user of the electronic device, if there are predefined images stored in the storage system; and
an execution module operable to send a message to a preset E-mail address or a mobile phone of an owner of the electronic device to notify the owner that an unauthorized user is using the electronic device in response to the user being an unauthorized user of the electronic device.

8. The electronic device according to claim 7, wherein the one or more programs further comprises:
a verification module operable to receive a password input by the user within a predetermined period of time, and determine whether the input password is valid, if no predefined image of the authorized users is stored in the storage system.

9. The electronic device according to claim 8, wherein the execution module further operable to send the message to the preset E-mail address or the mobile phone upon the condition that the input password is invalid.

10. The electronic device according to claim 8, wherein the one or more programs further comprises:
a setting module operable to collect the predefined images of the authorized users using the image capturing device, preset the password, the E-mail address and a phone number of the mobile phone, and store the predefined images, the password, the E-mail address and the phone number in the storage system.

11. The electronic device according to claim 7, wherein the message comprises the digital image of the user, time information that the digital image is captured, and an IP address used by the electronic device.

12. The electronic device according to claim 7, wherein the password is a fingerprint, a vocal print, or a character string preset by the owner.

13. The electronic device according to claim 7, wherein the authorized users comprises the owner and other persons that are allowed by the owner to use the electronic device.

14. A non-transitory storage medium storing a set of instructions, the set of instructions capable of being executed by a processor of an electronic device, to perform a method for identifying use by unauthorized users of the electronic device, the method comprising:
capturing a digital image of a user using an image capturing device of the electronic device when the user powers on the electronic device, and determining whether there are predefined images of authorized users of the electronic device stored in a storage system of the electronic device;
comparing the digital image with each of the predefined images to determine whether the user is an authorized user of the electronic device, if there are predefined images stored in the storage system; and
sending a message to a preset E-mail address or a mobile phone of an owner of the electronic device to notify the owner that an unauthorized user is using the electronic device in response to the user being an unauthorized user of the electronic device.

15. The storage medium as claimed in claim 14, wherein the method further comprises:
receiving a password input by the user within a predetermined period of time, if there is no predefined image of the authorized users stored in the storage system;
determining whether the input password is valid; and
sending the message to the preset E-mail address or the mobile phone upon the condition that the input password is invalid.

16. The storage medium as claimed in claim 15, wherein the method further comprises:
collecting the predefined images of the authorized users using the image capturing device;
presetting the password, the E-mail address and a phone number of the mobile phone; and
storing the predefined images, the password, the E-mail address and the phone number in the storage system.

17. The storage medium as claimed in claim 14, wherein the message comprises the digital image of the user, time information that the digital image is captured, and an IP address used by the electronic device.

18. The storage medium as claimed in claim 14, wherein the password is a fingerprint, a vocal print, or a character string preset by the owner.

19. The storage medium as claimed in claim 14, wherein the authorized users comprises the owner and other persons that are allowed by the owner to use the electronic device.
